(19) United States
(12) Patent Application Publication
(10) Pub. No.: US 2012/0209666 A1
(43) Pub. Date: Aug. 16, 2012

(54) HOTLINE SYSTEM FOR THE PURCHASE OF A PARKING SPACE, INCLUDING A PARKING TICKET MACHINE FOR PUBLIC ROADS AND A HOTLINE DEVICE

(75) Inventor: Olivier DEBAC, Besancon (FR)

(73) Assignee: PARKEON, Paris (FR)

(21) Appl. No.: 13/330,425

(22) Filed: Dec. 19, 2011

(30) Foreign Application Priority Data
Dec. 20, 2010 (FR) 1060843

(51) Int. Cl. G07B 15/02

(52) U.S. Cl. 705/13

(57) ABSTRACT

A hotline system for the purchase of parking spaces comprises a parking space payment device, which device includes a screen, display means for displaying data on the screen, and a computer-based hotline device connected to the payment device via a data transfer connection, comprising a receiver for receiving operational data received from the payment device and a transmitter for transmitting to the payment device control signals for controlling the payment device. The hotline device and the payment device each include a radioelectric transmitter-receiver, whereby the hotline device and the payment device are connected via a radioelectric connection, in the absence of a wired data transfer connection between the hotline device and the payment device, and in that the hotline device includes simulation means for simulating, based on the operational data received, the behavior of the payment device.

### CROSS-REFERENCE TO RELATED APPLICATIONS

This patent application claims priority to French patent application no. FR1060843, filed Dec. 20, 2010, the disclosure of which is herein incorporated by reference in its entirety.

### FIELD

This disclosure concerns a hotline system for the purchase of parking spaces, comprising a parking space payment device, which device includes a screen, display means for displaying data on the screen, and a computer-based hotline device connected to the payment device via a data transfer connection, comprising a receiver for receiving operational data delivered from the payment device and a transmitter for transmitting to the payment device control signals for controlling the payment device.

### BACKGROUND

A hotline system comprising a payment device for a parking space in a closed carpark and a computer-based hotline system connected to the payment device by means of a wired data transfer connection is known from prior art. The hotline system comprises means of receiving operational data from the payment device, in order, e.g., to allow for remote diagnosis of a malfunction of the payment device. The hotline device further comprises means of transmitting to the payment device command signals for the payment device, in order, e.g., to remotely correct the malfunction. The operational data and the command signals pass through the fixed data transfer connection; its significant data flow allows for the transmission of all data without limitation as to the size of the data packets transmitted.

However, such a hotline system for the purchase of a parking space is intended solely for a payment device in a closed carpark, with the payment device connected to the computer-based hotline device via the wired data transfer connection.

### SUMMARY

An object of the disclosure is to provide a hotline system for the purchase of a parking space for use with a payment device in the street, whereby the payment device is not connected to the computer-based hotline system via a wired data connection.

To this end, the disclosure concerns a hotline system of the aforementioned type, characterized in that the hotline device and the payment device each have a radioelectric transmitter-receiver device, and the hotline device and the payment device are connected radioelectrically with one another in the absence of a wired data transfer connection between the hotline device and the payment device, and in that the hotline device comprises simulation means for simulating the behavior of the payment device based on the operational data received, in the absence of all data related to the behavior of the payment device exchanged within the payment device.

In other embodiments, the hotline system has one or more of the following characteristics, either in isolation or in any and all technically possible combinations:
the simulation means are capable of simulating an image of the data displayed by the display device on the screen of the payment device;
the simulation means are capable of simulating the image of the data displayed by the display device on the screen of the payment device in the absence of the transmission of all of the data displayed by the payment device to the hotline device;
the hotline device comprises a hotline server connected by Internet to a remote server including the radioelectric transmitter-receiver, whereby the hotline server includes the simulation means;
the system additionally includes at least one web client capable of being used by a hotline operator, wherein the/each web client connected to the hotline device via the Internet network;
the hepline device includes transfer means for transferring to the corresponding web client data related to the behavior simulated by the simulation means;
the hotline device includes sending means for sending a request of the web address of the payment device;
the web address of the hotline device is predetermined and stored in the memory of the payment device;
the payment device includes voice transmission means for transmitting voice according to the Internet protocol, the voice transmission means being capable of allowing for voice communication between a user of the payment device and a hotline operator; and
the payment device is a parking ticket machine located in the street.

### BRIEF DESCRIPTION OF THE DRAWINGS

These characteristics and benefits of the disclosure will become clear from the following description, provided by way of example only, which refers to the figures appended hereto, in which:

FIG. 1 is a schematic representation of a hotline system disclosed, and

FIG. 2 is a flowchart illustrating remote assistance provided by an operator to a user of a parking ticket machine who is seeking to purchase a parking space.

### DETAILED DESCRIPTION

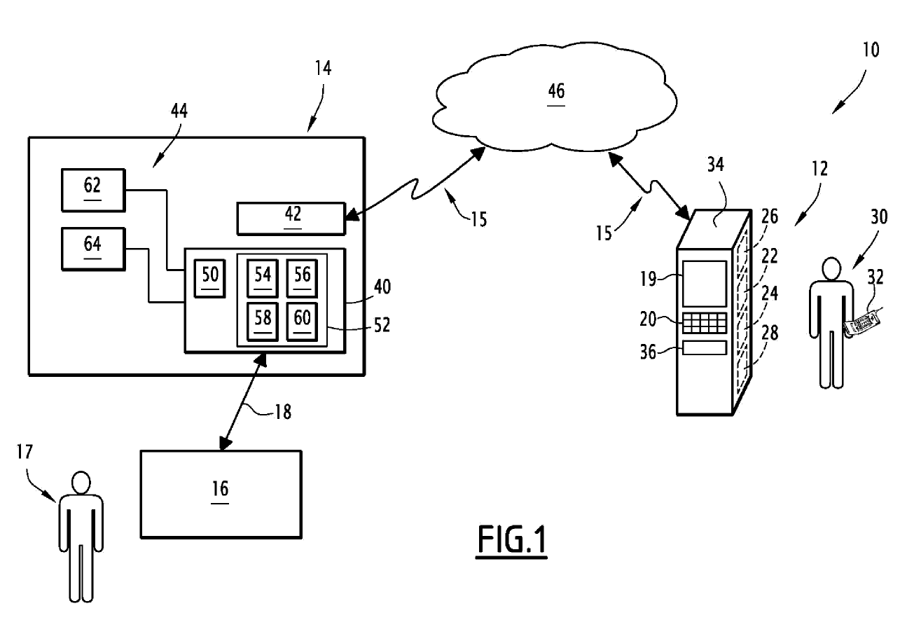

In FIG. 1, a hotline system 10 for the purchase of a parking space comprises a payment device 12 for a parking space and a computer-based hotline device 14 connected to the payment device by a radioelectric connection 15, in the absence of a wired data transfer connection between the payment device 12 and the hotline device 14. The hotline system 10 lacks, for example, a wired data transfer connection between the payment device 12 and the hotline device 14.

In the exemplary embodiment shown in FIG. 1, the hotline system 10 also includes a web client 16 capable of being used by a hotline operator 17, which web client 16 is connected to the hotline device 14 by means of the Internet 18 via a wired Ethernet connection.

The payment device 12 includes a screen 19, character capture device 20, and means 22 for displaying data on the screen. The payment device 12 includes a processor 24, a radioelectric transmitter-receiver 26, and a power supply 28 for the payment device. The payment device 12 includes means, not shown, of accepting methods of payment, such as a currency selector and/or a payment card reader.

The payment device 12 is placed in a public road, and is capable of being used by a user 30 with a cellular telephone 32.

In the exemplary embodiment shown in FIG. 1, the payment device 12 has no wired connection to an external device; the power supply 28 includes a rechargeable battery, not shown, capable of being recharged by means of a solar panel 34 placed on the top of the payment device. In another variant, the payment device 12 is connected to a power grid by means of a fixed electrical connection.

The payment device 12 includes, e.g., voice transmission means 36 for transmitting voice by Internet protocol (VoIP) the voice transmission means being adapted for allowing voice communication between the user 30 and the hotline operator 17. The voice transmission means 36 are particularly useful if the user 30 does not have a cellular telephone.

The payment device 12 is, e.g., a parking ticket machine.

The hotline device 14 includes a processor 40 and a radioelectric transmitter-receiver 42. The hotline device 14 according to the invention includes simulation means 44 for simulating based on operational data received from the payment device, the behavior of the payment device 12, in particular an image of the data displayed by the display device 22 on the screen of the payment device. The hotline device 14 has a web address, which may be predetermined.

In one variant, the hotline device 14 includes a hotline server, not shown, connected by Internet to a remote server including the radioelectric transmitter-receiver 42, whereby the hotline server includes the processor 40 and the simulation means 44.

The radioelectric connection 15 between the hotline device and the payment device includes, e.g., a mobile telephone network connection 46. The mobile telephone network is, e.g., a GPRS (General Packet Radio Service) or UTMTS (Universal Mobile Telecommunications System), or a CDMA (Code Division Multiple Access) network. The data flowrate of the radioelectric connection 15 does not allow for the transmission of all data related to the behavior of the payment device exchanged within the payment device.

In one variant, the data transfer connection between the hotline server and the payment device includes, by way of example, a connection to a mobile phone network 46 between the payment device and the remote server, as well as an Internet connection between the remote server and the hotline server.

The web client 16 includes a display device and receiving means for receiving commands from the hotline operator, not shown. The display device is capable of displaying the payment device 12 as a whole, i.e., the image displayed on the screen of the payment device, as well as any information received by the user. The receiving means are adapted for allowing the hotline device 14 to send a control signal to the payment device 12.

The processor 24 includes, by way of example, a data processor associated with a memory, not shown. The memory is capable of storing software to receive requests from the web address of the payment device from the hotline device, software for transmission to the hotline device of operational data related to the behavior of the payment device, and software to receive control signals from the hotline device. The memory is also capable of storing the predetermined web address of the hotline device 14.

The radioelectric transmitter-receiver 26 complies with the mobile phone standard implemented by the mobile phone network 46, such as the GSM (Global System for Mobile communications) standard, with, by way of example, the GPRS or UMTS system, or the CDMA standard.

The processor 40 includes, by way of example, a data processor 50 associated with a memory 52. The memory 52 is capable of storing software 54 for receiving operational data from the payment device and software 56 for transmitting to the payment device 12 control signals from the payment device. The memory 52 is also capable of storing software 58 for the transfer of behavioral data simulated by the simulation means to the web client 16 and software 60 for sending requests of the web address of the payment device.

In one variant, the receiver 54, the transmitter 56, the transfer software 58, and the transmitter 60 are in the form of programmable logic components, or of dedicated integrated circuit(s).

The operational data receiver 54 and the control signal transmitter 56 are capable of operating in real time.

The transmitter 56 is capable of receiving a transmission order from the receiver of the web client 16.

The radioelectric transmitter-receiver 42 complies with the mobile phone standard implemented by the mobile network 46, such as the GSM standard, with, by way of example, the GPRS or UMTS system, or the CDMA standard.

The simulation means 44 are adapted for simulating the behavior of the payment device 12 in the absence of all data related to the behavior of the payment device exchanged within the payment device. The simulation means 44 are capable, in particular, of simulating the image of the data displayed by the display device 22 on the screen of the payment device in the absence of the transmission of all of the data displayed by the payment device 12 to the hotline device 14.

The simulation means 44 include, by way of example, a first simulator 62 capable of simulating the image of the data displayed by the display device 22 and a second simulator 64 capable of simulating the behavior of the payment device 12, with the exception of the images generated by the display 22.

In one variant, the simulation means include one simulator for each payment device on the hotline. Each simulator is thus only capable of simulating the behavior of the hotline-assisted payment device, including the images generated by the display of the payment device, during the hotline phase of the respective payment device. At the end of the respective hotline phase, each simulator is capable of simulating the behavior of another payment device.

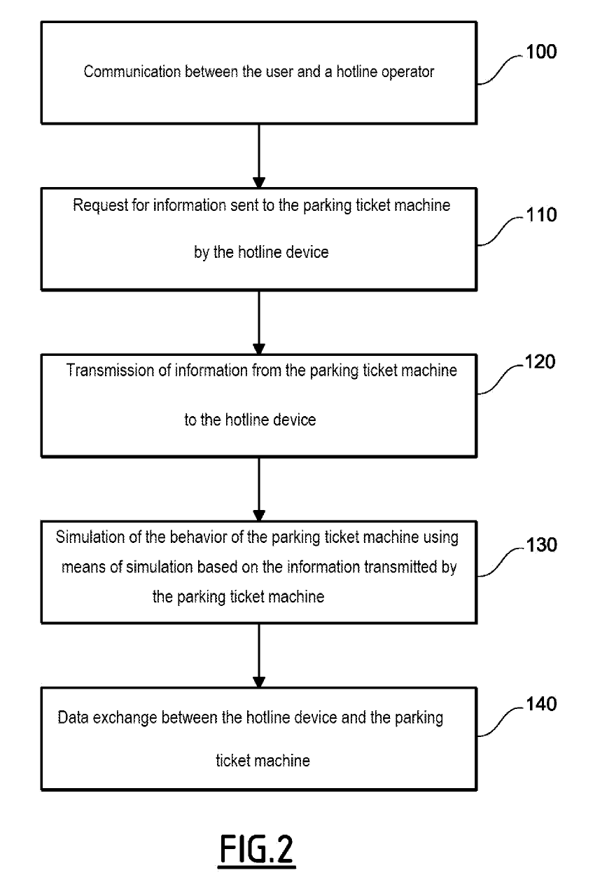

The operation of the hotline system 10 according to the invention will now be explained using the flowchart in FIG. 2.

When the user 30 of a payment device needs assistance from a person in order to operate the payment device, or discovers a malfunction of the payment device, the user calls, using his cellular telephone 32, the hotline operator 17 (stage 100) at the hotline number shown on the payment device. In one variant, contact between the user 30 and the operator 17 is established using a voice over Internet protocol transmitter 36.

On the command of the operator 17, the hotline device 14 sends to the payment device 12 a request for its web address using the transmitter 60 (stage 110). It is necessary for the hotline device to request the web address, also known as an IP (Internet Protocol) address, of the payment device 12 every time, as it is not actually a static address. The payment device 12 regularly goes into sleep mode in order to preserve the autonomy of its power supply battery.

The payment device 12 then transmits its IP address to the hotline device, which has a predetermined IP address that is stored in the memory of the payment device. The payment device 12 also transmits operational data (stage 120) to the hotline device 14 in response to its request. The operational data transmitted by the payment device are reduced in size due to the limited data flowrate of the radioelectric connection 15. The operational data transmitted include, by way of example, coded descriptions from the parking ticket machine describing in a coded fashion the possible conditions of the payment device. The data transmitted through the radioelectric connection 15 does not include all data related to the behavior of the payment device exchanged within the payment device.

The data on the behavior of the payment device include, by way of example, the following information:

the value and type of currency inserted into the currency selector,

the type of card inserted into the payment card reader,

the data captured or touch validated during an interaction of the user with the capture device 20.

the condition of the machine (malfunction or failure in course, rechargeable battery level, payer level if the parking ticket machine includes a printer),

the status of the connection with a bank authorization server, and

the status of the connection with an electronic ticket server.

The hotline device 14 then simulates, using the simulation means 44, the behavior of the payment device (stage 130), whereby the data related to the simulated behavior have been transferred to the web client 16 by the means of transfer 58. The web client 16 then reproduces the behavior of the payment device on the hotline, allowing the operator 17 to better assist the user 30, with the hotline device 14 sending, if necessary, control signals to the payment device 12 using its transmitter 56.

The hotline device 14 and the payment device 12 exchange data via the radioelectric connection 15 until the end of the hotline phase (stage 140).

Amongst other things, the hotline operator, via the web client 16, executes an action on the payment device 12, such as cancellation of a pending transaction, reprinting a ticket and/or a receipt, reimbursing an amount to a payment card other than a bank card, or the validation of a touch of the payment device 12 when the user is not able to take such an action himself.

According to the disclosure, the behavior of the payment device is simulated by the simulation means 44 of the hotline device in the absence of all of the data on the behavior of the payment device exchanged within the payment device. This allows for the remote reproduction of the behavior of the payment device despite the limited data flowrate of the radioelectric connection 15. The simulation means 44 thus allow the provision of remote assistance for the purchase of a parking space in the absence of a wired data transfer connection between the hotline device 14 and the payment device 12.

The web client 16 allows the hotline operator to intervene using a classic computer connected to the Internet without necessarily being near the hotline device 14.

It can thus be seen that the hotline system according to the disclosure provides a remote assistance for the purchase of a parking space for use with an autonomous payment device in the street, whereby the payment device is not connected to the computer-based hotline system via a wired data connection.

1. A hotline system for the purchase of a parking space, comprising:
a payment device for paying a parking space, which payment device includes a screen and display means for displaying data on the screen,
a computer-based hotline device connected to the payment device via a data transfer connection comprising a receiver for receiving operational data from the payment device and a transmitter for transmitting to the payment device control signals for controlling the payment device,
wherein the hotline device and the payment device each include a radioelectric transmitter-receiver, whereby the hotline device and the payment device are connected via a radioelectric connection, in the absence of a wired data transfer connection between the hotline device and the payment device, and wherein the hotline device includes simulation means for simulating, based on the operational data received, the behavior of the payment device in the absence of all data related to the behavior of the payment device exchanged within the payment device.

2. System according to claim 1, wherein the simulation means are capable of simulating an image of the data displayed by the display device on the screen of the payment device.

3. System according to claim 2, wherein the simulation means are capable of simulating the image of the data displayed by the display device on the screen of the payment device in the absence of the transmission of all of the data displayed by the payment device to the hotline device.

4. System according to claim 1, wherein the hotline device comprises a hotline server connected by Internet to a remote server including the radioelectric transmitter-receiver, whereby the hotline server includes the simulation means.

5. System according to claim 1, additionally including at least one web client capable of being used by a hotline operator, wherein the/each web client is connected to the hotline device via the Internet network.

6. System according to claim 5, wherein the hotline device includes transfer means for transferring to the corresponding web client data related to the behavior simulated by the simulation means.

7. System according to claim 1, wherein the hotline device includes sending means for sending a request of the web address of the payment device.

8. System according to claim 1 wherein the web address of the hotline device is predetermined and stored in a memory of the payment device.

9. System according to claim 1, wherein the payment device includes voice transmission means for transmitting voice according to the Internet protocol, the voice transmission means being capable of allowing for voice communication between a user of the payment device and a hotline operator.

10. System according to claim 1, wherein the payment device is a parking ticket machine located in the street.
